(19) United States
(12) Patent Application Publication
(10) Pub. No.: US 2026/0260782 A1
(43) Pub. Date: Sep. 3, 2026

(54) BUS BAR AND SHIELDED ELECTRIC WIRE

(71) Applicant: YAZAKI CORPORATION, Tokyo (JP)

(72) Inventor: Kazuyoshi KAGAMI, Shizuoka (JP)

(73) Assignee: YAZAKI CORPORATION, Tokyo (JP)

(21) Appl. No.: 19/557,649

(22) Filed: Mar. 5, 2026

Related U.S. Application Data
(63) Continuation of application No. PCT/JP2024/038466, filed on Oct. 29, 2024.

(30) Foreign Application Priority Data
Nov. 8, 2023 (JP) 2023-190855

(51) Int. Cl. H01B 7/42

(52) U.S. Cl. CPC H01B 7/42

(57) ABSTRACT

Provided is a bus bar and a shielded electric wire capable of improving heat dissipation efficiency without increasing a weight. A bus bar includes a conductor layer, an insulator layer covering an outer periphery of the conductor layer, and a shielded layer covering an outer periphery of the insulator layer. The thermal conductivity of the insulator layer is 0.2 [W/m·k] or more.

### CROSS-REFERENCE TO RELATED APPLICATIONS

This is a continuation of International Application No. PCT/JP2024/038466 filed on Oct. 29, 2024, and claims priority from Japanese Patent Application No. 2023-190855 filed on Nov. 8, 2023, the entire content of which is incorporated herein by reference.

### TECHNICAL FIELD

The present invention relates to a bus bar and a shielded electric wire.

BACKGROUND ART

In the related art, as a shielded electric wire routed in a vehicle, a shielded electric wire using a bus bar having three layers of a conductor layer, an insulator layer, and a shielded layer is known (see Patent Literature 1).

### CITATION LIST

### Patent Literature

Patent Literature 1: WO2021/188438

### SUMMARY OF INVENTION

### Technical Problem

When the shielded electric wire described in Patent Literature 1 is used as a routing member for allowing a current of a drive system of an electric vehicle to flow, heat generation of the conductor layer is increased due to a large current flowing through the bus bar as compared with a case where the shielded electric wire is used as a routing member for distributing a current from a low-voltage power supply to an auxiliary device or the like on the vehicle. However, it is difficult to say that the heat generation efficiency of the shielded electric wire described in Patent Literature 1 is sufficiently studied in consideration of material characteristics of the insulator layer and the shielded layer.

The present invention has been made in view of the above circumstances, and an object of the present invention is to provide a bus bar and a shielded electric wire capable of ensuring sufficient heat dissipation efficiency even when a large current flows through a conductor layer.

### Solution to Problem

In order to achieve the above object, a bus bar and a shielded electric wire according to the present invention are characterized as follows.

A bus bar includes:
a conductor layer;
an insulator layer covering an outer periphery of the conductor layer; and
a shielded layer covering an outer periphery of the insulator layer, in which
a thermal conductivity of the insulator layer is 0.2 [W/m·k] or more.

A shielded electric wire uses the bus bar.

### Advantageous Effects of Invention

According to the present invention, it is possible to provide a bus bar and a shielded electric wire capable of improving heat dissipation efficiency without increasing the entire weight.

The present invention has been briefly described above. Further, details of the present invention can be clarified by reading a mode (hereinafter, referred to as an “embodiment”) for carrying out the invention to be described below with reference to the attached drawings.

### BRIEF DESCRIPTION OF DRAWINGS

FIG. 1 is a schematic view showing a configuration of a bus bar according to an embodiment.

FIG. 2 is a graph showing a change in conductor temperature for each thermal conductivity of an insulator layer.

FIG. 3 is a graph showing a change in conductor temperature for each emissivity of a shielded layer.

FIG. 4 is a graph showing a change in conductor temperature when the thermal conductivity and the emissivity are simultaneously adjusted.

FIG. 5 is a graph showing a change in conductor temperature for each diameter of a conductor layer.

FIG. 6 is a graph showing a relationship between the thermal conductivity of the insulator layer and the conductor temperature for each thickness of the insulator layer when a thickness of the shielded layer is 0.5 mm.

FIG. 7 is a graph showing a relationship between the thermal conductivity of the insulator layer and the conductor temperature for each thickness of the insulator layer when the thickness of the shielded layer is 1.0 mm.

FIG. 8 is a graph showing a relationship between the thermal conductivity of the insulator layer and the conductor temperature for each thickness of the insulator layer when the thickness of the shielded layer is 1.5 mm.

### DESCRIPTION OF EMBODIMENTS

A specific embodiment of the present invention will be described below with reference to the drawings.

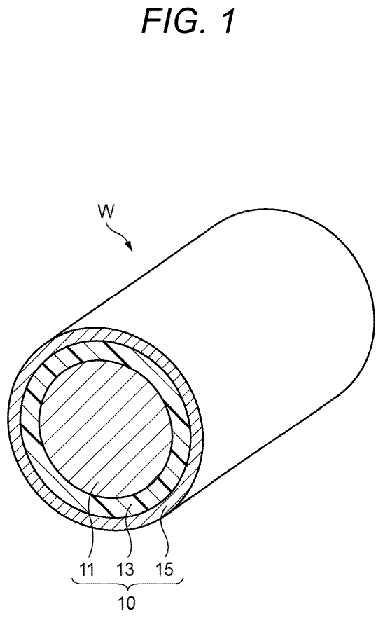

FIG. 1 is a schematic view showing a configuration of a bus bar 10 in the present embodiment.

As shown in FIG. 1, the bus bar 10 in the present embodiment includes a conductor layer 11 having a circular cross section, an insulator layer 13 covering an outer periphery of the conductor layer 11, and a shielded layer 15 covering an outer periphery of the insulator layer. As an example, the bus bar 10 constitutes a part of a shielded electric wire W including connectors at both ends.

In the present embodiment, the conductor layer 11 and the shielded layer 15 are formed of aluminum, and the insulator layer 13 is formed of polyethylene. Another conductor such as copper may be used for the conductor layer 11 and the shielded layer 15.

The insulator layer 13 functions as a covering member for the conductor layer 11. As will be described later, the insulator layer 13 may be formed of a material other than polyethylene as long as it has a predetermined thermal conductivity. When the material constituting the insulator layer 13 contains a phase change material (PCM), the insulator layer 13 is softened by the heat generated by the conductor layer 11 and comes into close contact with the conductor layer 11, so that the heat dissipation efficiency of the conductor layer 11 is preferably increased.

Heat generated in the conductor layer 11 due to the current flowing through the bus bar 10 is thermally conducted by the insulator layer 13 and the shielded layer 15, and is dissipated by radiation from a surface of the shielded layer 15. The heat dissipation by the radiation is defined by the Stefan-Boltzmann law.

$$Q = 5.67 * {10}^{- 8} ε {T}^{4}$$

Where Q is the amount of dissipated heat [W/m²], ε is the emissivity, and T is the temperature [K].

According to the Stefan-Boltzmann law, the higher the emissivity, the greater the heat dissipation effect by radiation. Examples of a method for increasing the emissivity of the shielded layer 15 include oxidizing the surface of the shielded layer 15, applying a coating material for increasing the emissivity to the surface, coating the surface with a sufficiently thin resin, and roughening the surface.

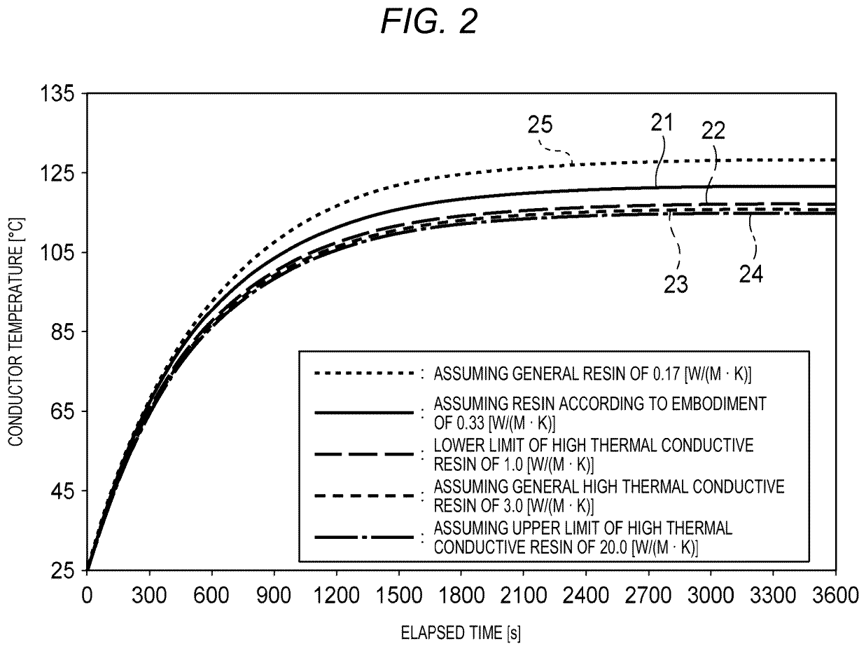

FIG. 2 is a graph showing a change in conductor temperature for each thermal conductivity of the insulator layer 13.

In the following analysis, it is assumed that the conductor layer 11 has a circular cross section and a cross-sectional area of 95 [mm²], and a current of 500 [A] is continuously applied to the conductor layer 11 for one hour. When the shielded electric wire W and the bus bar 10 are actually routed a vehicle, these lengths are set to any length according to the purpose, but in analysis, these lengths may be any length because the cross-sectional area of the cross-sectional shape is constant. In this analysis, a length of the bus bar 10 is 50 [mm]. A thickness of the insulator layer is set to 1.5 [mm], and a thickness of the shielded layer 15 is set to 1.0 [mm].

In the graph of FIG. 2, a solid line 21 indicates a case of the resin according to the present embodiment in which the thermal conductivity of the insulator layer 13 is 0.33 [W/m·K], a broken line 22 indicates a case assuming that a relatively low thermal conductivity of a resin among high thermal conductive resins is 1.0 [W/m·K], a broken line 23 indicates a case assuming that a thermal conductivity of a general high thermal conductive resin is 3.0 [W/m·K], a broken line 24 indicates a case assuming that an upper limit thermal conductivity of a resin among the high thermal conductive resins is 20.0 [W/m·K], and a dotted line 25 indicates a case assuming that a thermal conductivity of a general resin is 0.17 [W/m·K]. In either case, the emissivity of the shielded layer 15 is set to 0.06 in the related art.

As shown in the graph of FIG. 2, it can be seen that in any case, the thermal conductivity is higher than that of the general resin in the related art, and the heat dissipation effect is higher as the thermal conductivity is higher. In particular, when the thermal conductivity of the insulator layer 13 is 0.33 [W/m·K], the increase in the conductor temperature can be sufficiently limited without increasing the thickness of the shielded layer 15.

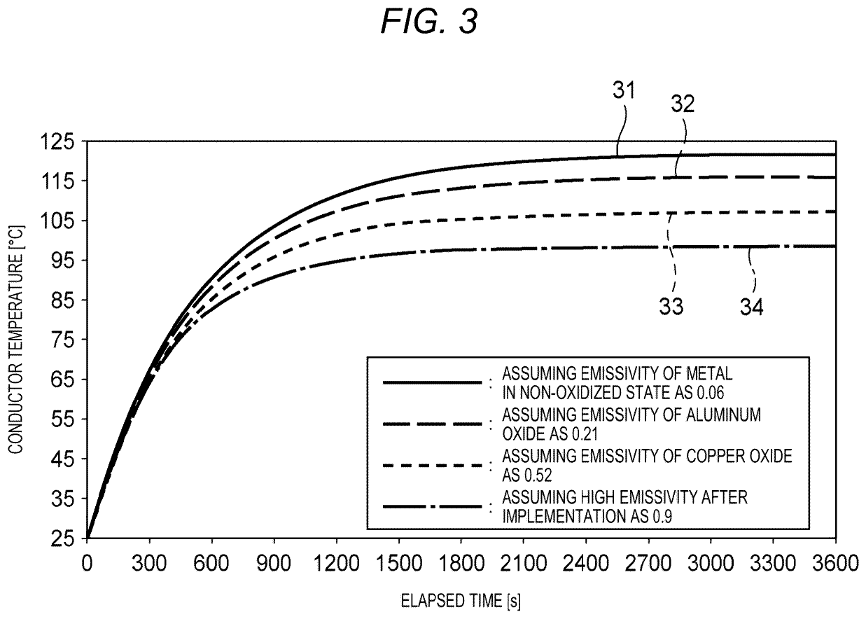

FIG. 3 is a graph showing a change in conductor temperature for each emissivity of the shielded layer 15.

In the graph of FIG. 3, a solid line 31 sets 0.06 as the emissivity of the shielded layer 15 assuming a metal in a non-oxidized state, a broken line 32 sets 0.21 as the emissivity of the shielded layer 15 assuming aluminum oxide, a broken line 33 sets 0.52 as the emissivity of the shielded layer 15 assuming copper oxide, and a broken line 34 sets 0.9 assuming the shielded layer 15 having a high emissivity. In either case, the thermal conductivity of the insulator layer 13 is set to 0.33 [W/m·K].

As shown in the graph of FIG. 3, it can be seen that the heat dissipation effect is higher as the emissivity of the shielded layer 15 is higher.

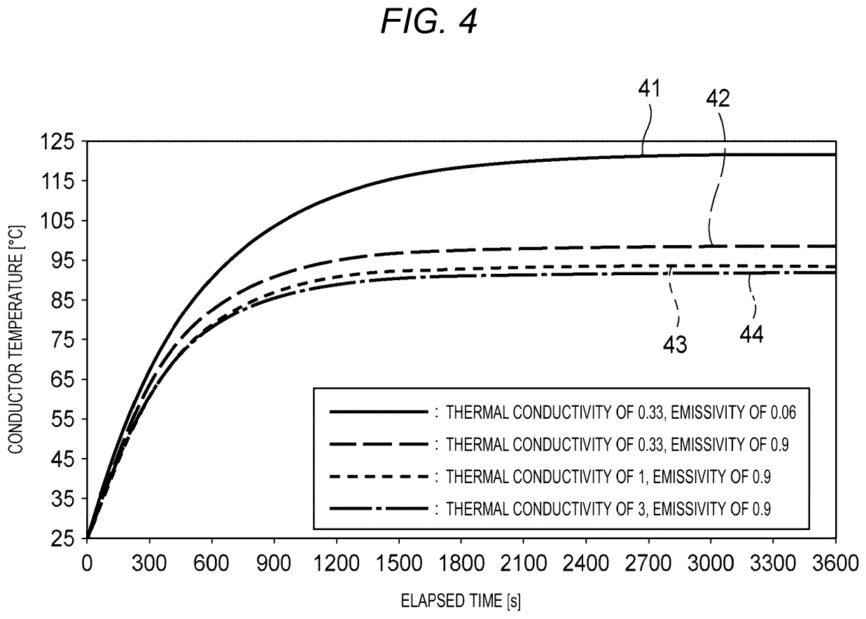

FIG. 4 is a graph showing a change in conductor temperature when the thermal conductivity and the emissivity are simultaneously adjusted.

In the graph of FIG. 4, a solid line 41 indicates a case where the thermal conductivity is 0.33 [W/m·K] and the emissivity is 0.06. A broken line 42 indicates a case where the thermal conductivity is 0.33 [W/m·K] and the emissivity is 0.9. A broken line 43 indicates a case where the thermal conductivity is 1.0 [W/m·K] and the emissivity is 0.9. A broken line 44 indicates a case where the thermal conductivity is 3.0 [W/m·K] and the emissivity is 0.9.

As shown in the graph of FIG. 4, it can be seen that the temperature of the conductor layer 11 can be reduced as the emissivity of the shielded layer 15 is higher. Further, it can be seen that even when the thermal conductivity of the insulator layer 13 is about 0.33 [W/m·K], the heat generation of the conductor layer 11 can be limited depending on the emissivity of the shielded layer 15.

In the above analysis, it can be seen that the heat generation of the conductor layer 11 can be limited by at least one of increasing the thermal conductivity of the insulator layer 13 and increasing the emissivity of the shielded layer 15. Therefore, when a cross-sectional area of the bus bar 10 having such a high heat dissipation effect is made smaller than that of the bus bar in the related art, the cross-sectional area having a heat dissipation effect similar to that of the bus bar in the related art is analyzed.

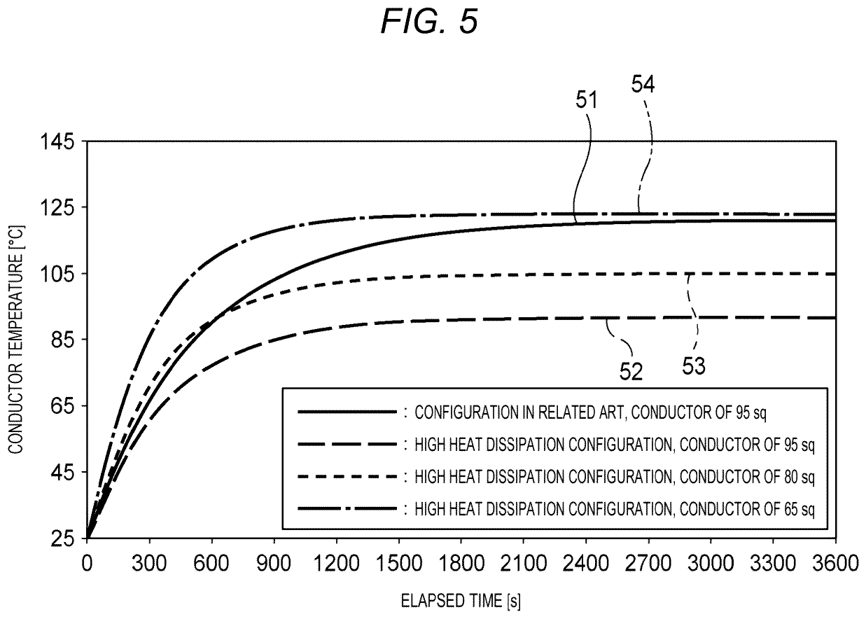

FIG. 5 is a graph showing a change in conductor temperature for each diameter of the conductor layer.

In the graph of FIG. 5, a solid line 51 indicates a case where the cross-sectional area is set to 95 [mm²] at a thermal conductivity of 0.33 [W/m·K]. Broken lines 52 to 54 indicate a case where the cross-sectional areas are set to 95 [mm²], 80 [mm²], and 65 [mm²], respectively, when the thermal conductivity is 3.0 [W/m·K] and the emissivity is 0.9.

As shown in the graph of FIG. 5, it can be seen that the temperature of the conductor layer 11 can be reduced by adjusting the thermal conductivity of the insulator layer 13 and the emissivity of the shielded layer 15 even when the cross-sectional area of the bus bar 10 is 65 [mm²].

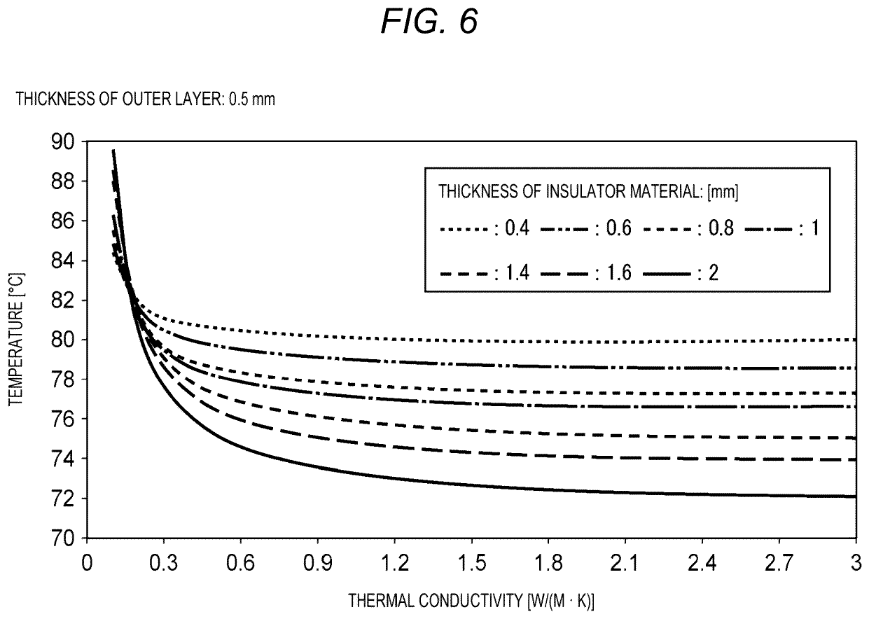

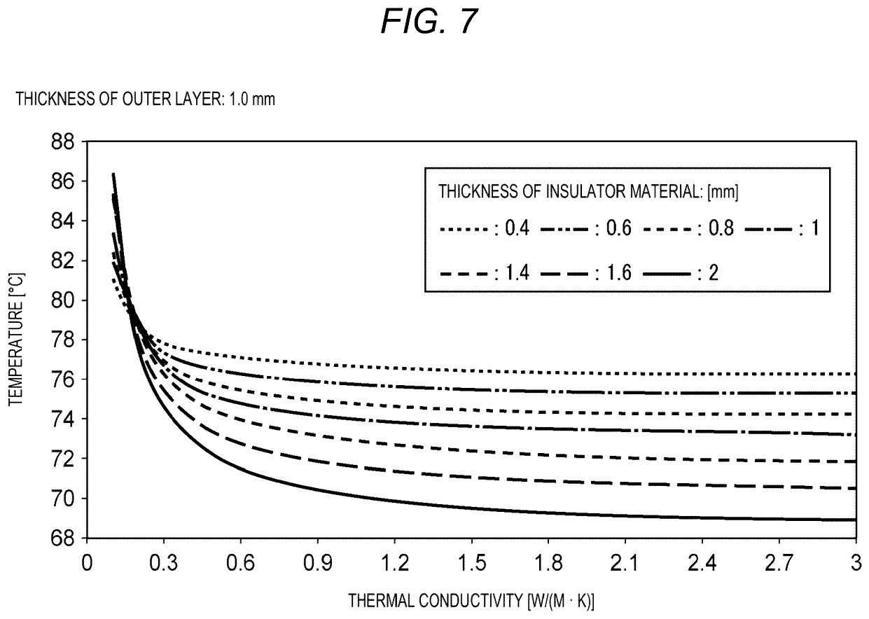

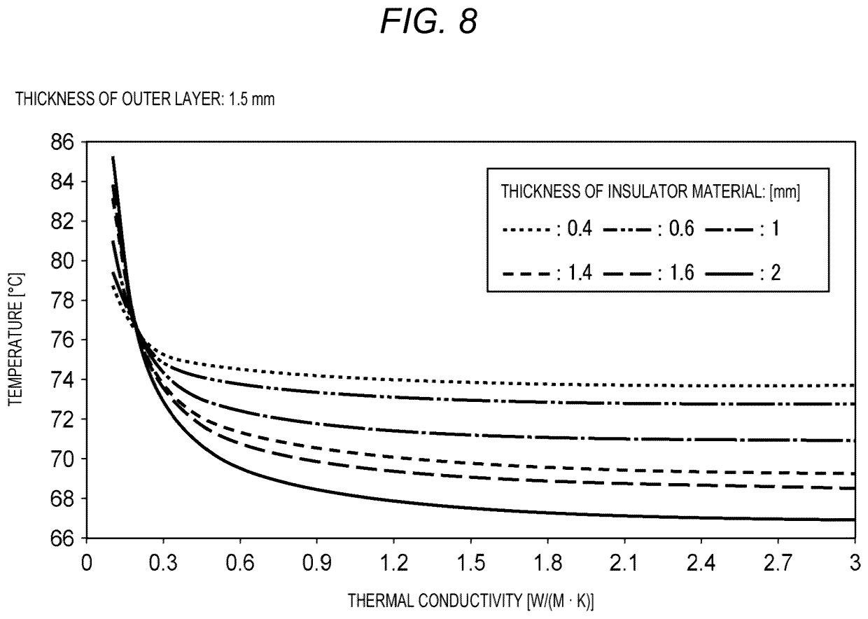

FIG. 6 is a graph showing a relationship between the thermal conductivity of the insulator layer 13 and the conductor temperature for each thickness of the insulator layer 13 when the thickness of the shielded layer 15 is 0.5 [mm]. FIG. 7 is a graph showing a relationship between the thermal conductivity of the insulator layer 13 and the conductor temperature for each thickness of the insulator layer 13 when the thickness of the shielded layer 15 is 1.0 [mm]. FIG. 8 is a graph showing a relationship between the thermal conductivity of the insulator layer 13 and the conductor temperature for each thickness of the insulator layer when the thickness of the shielded layer 15 is 1.5 [mm]. In either case, it is assumed that the cross-sectional area of the conductor layer 11 is set to 95 [mm²] and a current of 500 [A] flows through the conductor layer 11.

As shown in FIGS. 6 to 8, regardless of the thickness of the shielded layer 15, the temperature of the conductor layer 11 increases as the thickness of the insulator layer 13 increases when the thermal conductivity of the insulator layer 13 is less than 0.2 [W/m·k], and the temperature of the conductor layer 11 increases as the thickness of the insulator layer 13 decreases when the thermal conductivity of the insulator layer 13 is 0.2 [W/m·k] or more, with 0.2 [W/m·k] as a boundary. This indicates that, in a region where the thermal conductivity of the insulator layer 13 is low, as the insulator layer 13 is thicker, the heat conduction to the outside is delayed, so that the temperature of the conductor layer 11 increases. On the other hand, when the thermal conductivity of the insulator layer 13 is high, the temperature of the conductor layer 11 decreases as the thickness of the insulator layer 13 increases and the heat capacity increases. Even when the current flowing through the conductor layer 11 is larger than 500 [A], a relationship between the thickness of the insulator layer 13 and the temperature of the conductor layer 11 is reversed, with the thermal conductivity of 0.2 [W/m·k] of the insulator layer 13 as a boundary.

Therefore, by setting the thermal conductivity of the insulator layer 13 to 0.2 [W/m·k] or more, the heat capacity of the insulator layer 13 increases, and the temperature rise of the conductor layer 11 can be limited. In particular, when the thickness of the shielded layer 15 is determined by the standard, by setting the thermal conductivity to a value of 0.2 [W/m·k] or more, the temperature rise of the conductor layer 11 can be limited even when the thickness of the shielded layer 15 cannot be optimized from the viewpoint of the heat dissipation efficiency.

The present invention is not limited to the embodiment described above, and can be appropriately modified, improved, or the like. In addition, materials, shapes, sizes, numbers, arrangement positions, and the like of components in the embodiment described above are freely selected and are not limited as long as the present invention can be implemented.

Here, features of the shielded electric wire and the bus bar according to the embodiment in the present invention described above are briefly summarized and listed in the following [1] to [3].

[1] A bus bar (10) including:
a conductor layer (11);
an insulator layer (13) covering an outer periphery of the conductor layer (11); and
a shielded layer (15) covering an outer periphery of the insulator layer (13), in which
a thermal conductivity of the insulator layer (13) is 0.2 [W/m·k] or more.

According to the bus bar having the configuration of [1], it is possible to implement a bus bar capable of ensuring sufficient heat dissipation efficiency even when a large current flows through the conductor layer. Therefore, it is possible to provide a bus bar having high radiation efficiency while limiting an increase in the weight of the entire bus bar caused by increasing the thickness of the shielded layer to increase the emissivity of the shielded layer, in order to increase the heat dissipation efficiency of the bus bar.

[2] The bus bar according to [1], in which
a material forming the insulator layer (13) contains a phase change material.

According to the bus bar having the configuration of [2], when the conductor layer is heated by the current, the insulator layer is softened and comes into close contact with the outer periphery of the conductor layer, so that the radiation efficiency from the conductor layer can be further improved.

[1] A shielded electric wire (W) using the bus bar (10) according to [1] or [2].

According to the shielded electric wire having the configuration of [3], the heat dissipation effect of the bus bar portion can be improved without increasing the weight of the bus bar, so that by using the bus bar for the shielded electric wire, the shielded electric wire can be used as an electric wire for a large current without increasing the weight of the entire electric wire.

Although various embodiments are described above, it is needless to say that the present invention is not limited to these examples. It is apparent that those skilled in the art can come up with various modifications or corrections within the scope of the claims, and it is understood that the modifications or corrections naturally fall within the technical scope of the present invention. In addition, components described in the above embodiments may be combined freely without departing from the spirit of the invention.

The present application is based on a Japanese patent application (JP2023-190855A) filed on Nov. 8, 2023, contents of which are incorporated herein by reference.

### REFERENCE SIGNS LIST

10: bus bar
11: conductor layer
13: insulator layer
15: shielded layer
W: shielded electric wire

1. A bus bar comprising:
a conductor;
an insulator layer covering an outer periphery of the conductor; and
a shielded layer covering an outer periphery of the insulator layer, wherein
a thermal conductivity of the insulator layer is 0.2 [W/m·k] or more regardless of a thickness of the shielded layer covering the insulator layer.

2. The bus bar according to claim 1, wherein
a material forming the insulator layer contains a phase change material.

3. A shielded electric wire using the bus bar according to claim 1.
